(19) United States
(12) Patent Application Publication
(10) Pub. No.: US 2026/0253948 A1
(43) Pub. Date: Aug. 27, 2026

(54) PREPARATION METHOD FOR SOLID ELECTROLYTE, SOLID ELECTROLYTE PREPARED THEREBY, AND ALL-SOLID-STATE BATTERY COMPRISING SAME

(71) Applicant: DAEJOO ELECTRONIC MATERIALS CO., LTD., Gyeonggi-do (KR)

(72) Inventors: Changhyeon KIM, Gyeonggi-do (KR); Yong KIM, Gyeonggi-do (KR); Saemi IM, Gyeonggi-do (KR); Minjun SEONG, Gyeonggi-do (KR); Young Min JEON, Gyeonggi-do (KR); Jong Chan LIM, Gyeonggi-do (KR)

(21) Appl. No.: 19/159,402

(22) PCT Filed: Aug. 2, 2024
(86) PCT No.: PCT/KR2024/011383

§ 371 Date: Aug. 25, 2025

(30) Foreign Application Priority Data
Aug. 30, 2023 (KR) 10-2023-0114778

(51) Int. Cl. H01M 10/0562

(52) U.S. Cl. CPC H01M 10/0562; H01M 2300/008

(57) ABSTRACT

The present invention provides an alkali metal ion-conductive chalcogenide-based solid electrolyte, wherein in order to mass-produce the solid electrolyte at a level that can be applied to all-solid-state batteries, Li2S is not used even when going through a complete dissolution method by which homogeneous synthesis can be performed, and a reaction is completed in one pot in a single solvent, thereby facilitating precursor recovery and solvent reuse and enabling high ionic conductivity.

### TECHNICAL FIELD

The present invention relates to a method for preparing a solid electrolyte, a solid electrolyte prepared thereby, and an all-solid-state battery comprising the same.

### BACKGROUND ART

In recent years, as the market for electric vehicles (battery electric vehicles; BEVs) powered by secondary batteries expands, the demand for improved safety of secondary batteries is increasing. In particular, lithium secondary batteries are being used as the main secondary batteries for electric vehicles since they have higher energy density than those of conventional lead-acid, Ni-MH, and Ni—Cd batteries. However, interest in all-solid-state batteries using solid electrolytes is increasing due to the leakage of organic electrolytes used in lithium secondary batteries and the high risk of fire.

Sulfide-based solid electrolytes, among inorganic solid electrolytes with high thermal stability, have high lithium-ion conductivity similar to that of liquid electrolytes and have unique softness; thus, they are being actively studied as electrolytes for all-solid-state batteries.

Sulfide-based solid electrolytes may be prepared by dry synthesis or wet synthesis. While dry synthesis may be carried out through such processes as raw material mixing, thermal treatment, and pulverization, it has the disadvantage of being difficult to mass-synthesize because some synthesis is mechanically performed after raw material mixing with high-energy rotational force, followed by thermal treatment.

Examples of wet synthesis for solid electrolytes include a suspension method in which a solid electrolyte precursor powder is formed in a polar aprotic solvent through dispersion and reaction, the powder is recovered, and it is then thermally treated; a dissolution method in which raw materials are completely dissolved as precursors in a polar protic solvent, a polar aprotic solvent, or a mixed solution thereof, and then dried and thermally treated; and a hybrid method in which a precursor is partially dissolved and then dried and thermally treated.

The suspension method has the advantage of being able to recover a particulate solid electrolyte precursor, whereas the compositional uniformity of the solid electrolyte precursor formed through the particle-particle reaction of raw material powders is low, the production speed is slow, the type of solid electrolyte that can be prepared by this method is limited, and the ionic conductivity is relatively low (1 mS/cm or less based on Li₃PS₄).

As a representative example of the dissolution method, Li₂S and P₂S₅ are reacted in THF to produce a Li₃PS₄·3THF precursor, this precursor or a solution thereof is then mixed with Li₂S and LiX (X=F, Cl, Br, or I) in ethanol to produce a completely dissolved precursor of Li₇₋ₐPS₆₋ₐXₐ (0≤a≤2), and the solvent is evaporated to recover the powder, followed by drying and thermal treatment to obtain a solid electrolyte powder of Li₇₋ₐPS₆₋ₐXₐ (0≤a≤2). It has been reported that a solid electrolyte with an ionic conductivity of 1 mS/cm or more can be synthesized through composition control in the case of the lithium-argyrodite (Li-argyrodite) structure represented by Li₇₋ₐPS₆₋ₐXₐ (0≤a≤2). However, this method has a disadvantage in that it requires an additional process of evaporating the solvent or precipitating the powder by adding it to a nonpolar solvent to recover the precursor powder from the completely dissolved solution.

Meanwhile, most solid electrolyte synthesis methods to date use Li₂S as a raw material. The core reaction, 3Li₂S+P₂S₅→2Li₃PS₄, in most wet synthesis methods is carried out internally with Li₂S as the core and Li₃PS₄ forming the shell. As a result, not only is the reaction rate slow, but it is also greatly affected by the purity, particle size, oxidation, and the like of Li₂S. Further, there are safety issues due to the use of a large amount of H₂S, a hazardous gas, for the synthesis of Li₂S, and the manufacturing process is complicated, thereby requiring additional costs for high purity. In addition, there is a difficulty in that it must be stored in an inert gas, and commercially marketed battery-grade high-purity Li₂S powder is sold at a high price of $1,000 or more per kg, which is a factor that impairs the price competitiveness of solid electrolyte materials using Li₂S as a raw material.

In recent years, a one-pot wet synthesis method using lithium metal that can secure price competitiveness has been reported, which has the advantage of being able to easily synthesize solid electrolytes in large quantities by introducing all raw materials for preparing solid electrolytes, reacting them, and then performing precipitation, filtration, drying, and thermal treatment. However, since it is prepared by combining the suspension method and the dissolution method, a non-uniform solid electrolyte is obtained, which has the disadvantage of having a low ionic conductivity at a level of 1.2 mS/cm.

In particular, even if a solid electrolyte is synthesized, particle size control is required through a pulverizing process in order to be applied to an all-solid-state battery. In general, ionic conductivity decreases during the particle size control process, and a high ionic conductivity of at least 3 mS/cm before pulverization is required in order to be applied to an all-solid-state battery.

### PRIOR ART DOCUMENT

(Patent Document 1) Korean Patent No. 1236059 (Feb. 15, 2013)

### DISCLOSURE OF INVENTION

### Technical Problem

As a result of research conducted by the present inventors in order to solve the above problems, a novel method has been devised in which a complete dissolution method for homogeneous synthesis is carried out to mass produce solid electrolytes applicable to all-solid-state batteries, without using Li₂S, and the reaction is completed in a single solvent in one pot, which facilitates recovery of the precursor and reuse of the solvent, and synthesizes a solid electrolyte with high ionic conductivity.

Accordingly, the task of the present invention is to provide a wet preparation method for an alkali metal ion-conductive chalcogenide-based solid electrolyte that enables mass production of an alkali metal ion-conductive chalcogenide-based solid electrolyte at low cost, a solid electrolyte with high ionic conductivity prepared thereby, and an all-solid-state battery comprising the same.

### Solution to Problem

In order to solve the above problems, the present invention provides a method for preparing an alkali metal ion-conductive chalcogenide-based solid electrolyte, which comprises (1) preparing a first precursor solution in which a precursor of an alkali metal ion-conductive chalcogenide-based solid electrolyte is completely dissolved in a polar aprotic solvent; (2) adding an alkali metal or an alkali metal-containing material to the first precursor solution to prepare a slurry in which a second precursor is dispersed; (3) recovering the second precursor in a powder form from the slurry; and (4) thermally treating the second precursor powder.

In addition, the present invention provides an alkali metal ion-conductive chalcogenide-based solid electrolyte prepared according to the above method and represented by the following Formula 1.

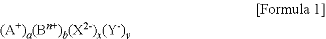

Here, A is one or more elements selected from Li, Na, and K; B is one or more elements belonging to Groups 2 to 15 of the periodic table; X is one or more elements selected from S, Se, and Te, or a combination thereof with O; Y is one or more elements or compounds selected from F, Cl, Br, I, CN, OCN, SCN, and N₃; a+(n*b)−(2*x)−y=0, a>0, x>0, and at least one of b and y is greater than 0.

In addition, the present invention provides an all-solid-state battery, which comprises the above alkali metal ion-conductive chalcogenide-based solid electrolyte.

### Advantageous Effects of Invention

According to the method of the present invention, a complete dissolution method for homogeneous synthesis is carried out to mass produce solid electrolytes applicable to all-solid-state batteries, without using Li₂S, and the reaction is completed in a single solvent in one pot, whereby recovery of the precursor and reuse of the solvent are facilitated, and an alkali metal ion-conductive chalcogenide-based solid electrolyte with high ionic conductivity of 3 mS/cm or more can be provided.

Accordingly, the present invention can provide a wet preparation method for an alkali metal ion-conductive chalcogenide-based solid electrolyte that enables mass production of an alkali metal ion-conductive chalcogenide-based solid electrolyte at low cost, a solid electrolyte with high ionic conductivity prepared thereby, and an all-solid-state battery comprising the same.

### BRIEF DESCRIPTION OF DRAWINGS

FIG. 1 shows a method for preparing an alkali metal ion-conductive chalcogenide-based solid electrolyte according to an embodiment of the present invention.

FIG. 2 shows a method for preparing a solid electrolyte (Li₆PS₅Cl) according to an embodiment.

FIG. 3 shows a photograph of a solution in which the first precursor in Example 1 is completely dissolved.

FIG. 4 shows a photograph of a slurry in which the second precursor in Example 1 is dispersed.

FIG. 5 shows an XRD pattern obtained from the solid electrolyte (Li₆PS₅Cl) of Example 1.

FIG. 6 shows the results of measuring the ionic conductivity of the solid electrolyte in Test Example 3.

FIG. 7 shows a graph of analyzing the particle size of the solid electrolyte in Test Example 3.

FIG. 8 shows the ionic conductivity of the solid electrolyte before and after exposure to air in Test Example 3.

FIG. 9 shows a charge and discharge curve measured for the all-solid-state battery in Test Example 4.

FIG. 10 shows the results of analyzing a solution, in which the first precursor is completely dissolved, using an electrospray ionization mass spectrometer.

### BEST MODE FOR CARRYING OUT THE INVENTION

In this specification, terms referring to the respective components are used to distinguish them from each other and are not intended to limit the scope of the embodiment. In addition, in the present specification, a singular expression is interpreted to cover a plural number as well unless otherwise specified in the context.

In the present specification, the terms first, second, and the like are used to describe various components. But the components should not be limited by the terms. The terms are used for the purpose of distinguishing one element from another.

In the present specification, the term “comprising” is intended to specify a particular characteristic, region, step, process, element, and/or component. It does not exclude the presence or addition of any other characteristic, region, step, process, element, and/or component, unless specifically stated to the contrary.

In the numerical range that limits the size and physical properties of components and the like described in the present specification, when a numerical range limited with the upper limit only and a numerical range limited with the lower limit only are separately exemplified, it should be understood that a numerical range combining these upper and lower limits is also encompassed in the exemplary scope of the invention.

According to an aspect of the present invention, there is provided a method for preparing an alkali metal ion-conductive chalcogenide-based solid electrolyte, which comprises (1) preparing a first precursor solution in which a precursor of an alkali metal ion-conductive chalcogenide-based solid electrolyte is completely dissolved in a polar aprotic solvent; (2) adding an alkali metal or an alkali metal-containing material to the first precursor solution to prepare a slurry in which a second precursor is dispersed; (3) recovering the second precursor in a powder form from the slurry; and (4) thermally treating the second precursor powder.

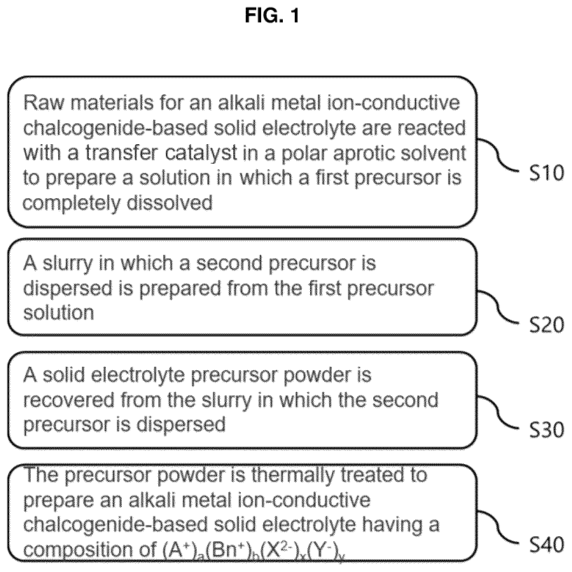

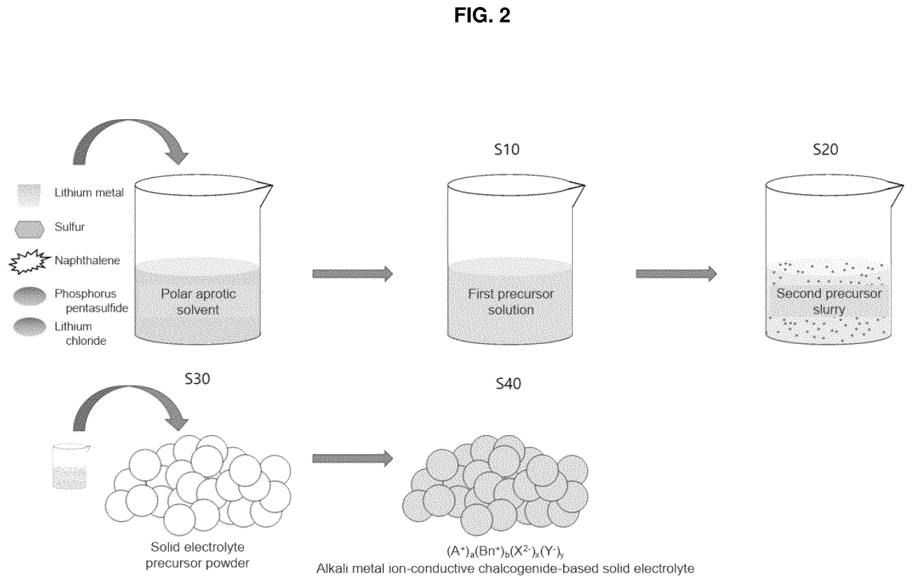

FIG. 1 shows a method for preparing an alkali metal ion-conductive chalcogenide-based solid electrolyte according to an embodiment of the present invention. FIG. 2 shows a method for preparing a solid electrolyte (Li₆PS₅Cl) according to an embodiment of the present invention.

Referring to FIGS. 1 and 2, the method for preparing an alkali metal ion-conductive chalcogenide-based solid electrolyte according to an embodiment comprises reacting raw materials for an alkali metal ion-conductive chalcogenide-based solid electrolyte, which comprise an alkali metal-containing material, a transfer catalyst that ionizes an alkali metal to transfer ions and electrons, a chalcogen element, and one or more element compounds from Groups 2 to 15 and 17 of the periodic table, in a polar aprotic solvent.

As a result, a first precursor solution is prepared in which a precursor of an alkali metal ion-conductive chalcogenide-based solid electrolyte is completely dissolved via an alkali metal polychalcogenide formed when ions and electrons are transferred from the alkali metal-containing material to the chalcogen element (S10). Thereafter, a step of adding an alkali metal or an alkali metal-containing material to the first precursor solution to prepare a slurry in which a second precursor is dispersed (S20); a step of recovering the alkali metal ion-conductive chalcogenide-based solid electrolyte precursor in a powder form from the slurry in which the second precursor is dispersed (S30); and a step of thermally treating the alkali metal ion-conductive chalcogenide-based solid electrolyte precursor powder (S40) are carried out.

Hereinafter, each step of the preparation method will be described in detail.

### Preparation of a First Precursor Solution

In step (1), a first precursor solution, in which a precursor of an alkali metal ion-conductive chalcogenide-based solid electrolyte is completely dissolved in a polar aprotic solvent, is prepared.

For example, the first precursor solution may be prepared by reacting raw materials for an alkali metal ion-conductive chalcogenide-based solid electrolyte in a polar aprotic solvent.

According to an embodiment, the first precursor solution may be prepared by reacting raw materials for an alkali metal ion-conductive chalcogenide-based solid electrolyte, which comprise (i) an alkali metal or an alkali metal-containing material, (ii) a transfer catalyst that ionizes the alkali metal to transfer ions and electrons, (iii) a chalcogen element, and (iv) one or more element compounds from Groups 2 to 15 and 17 of the periodic table, in the polar aprotic solvent.

The alkali metal-containing material may be, for example, an alkali metal-transfer catalyst radical solution formed by reacting an alkali metal with the transfer catalyst in the polar aprotic solvent.

As an example, an alkali metal may be used alone in the preparation of the first precursor solution. The alkali metal may be a component that belongs to Group 1 in the periodic table. Specifically, the alkali metal may be at least one selected from the group consisting of lithium (Li), sodium (Na), and potassium (K).

As another example, an alkali metal-containing material may be used in the preparation of the first precursor solution. The alkali metal-containing material may be an alkali metal-transfer catalyst radical solution formed by reacting an alkali metal with a transfer catalyst in a polar aprotic solvent. As an alkali metal-transfer catalyst radical solution is prepared in advance and then reacted, there is an effect of reducing the time required to dissolve and react the alkali metal.

As another example, a mixture of an alkali metal and an alkali metal-containing material may be used in the preparation of the first precursor solution.

The transfer catalyst that ionizes an alkali metal to transfer ions and electrons may be, for example, one or more polycyclic aromatic hydrocarbons (PAHs). Specifically, the transfer catalyst may be selected from the group consisting of naphthalene, acenaphthylene, acenaphthene, biphenyl, fluorene, phenanthrene, anthracene, fluoranthene, pyrene, benzo[a]anthracene, chrysene, benzo[k]fluoranthene, benzo[b]fluoranthene, benzo[a]pyrene, indeno[1,2,3-cd]pyrene, dibenz[a,h]anthracene, and benzo[ghi]perylene.

In addition, the chalcogen element may be, for example, one or more elements selected from the group consisting of sulfur(S), selenium (Se), tellurium (Te), and oxygen (O). Specifically, the chalcogen element may be at least one selected from the group consisting of sulfur(S), selenium (Se), and tellurium (Te), or a combination thereof with oxygen (O).

The raw materials for an alkali metal ion-conductive chalcogenide-based solid electrolyte exemplified above may be reacted in a polar aprotic solvent to prepare the first precursor solution.

The polar aprotic solvent may be, for example, an ether-based solvent, a vinyl-based solvent, an amide-based solvent, an acetate-based solvent, a carbonate-based solvent, an ester-based solvent, or a mixed solvent of one or more thereof. Specifically, the polar aprotic solvent may be at least one selected from the group consisting of an aliphatic monoether, an aliphatic diether, a cyclic ether, a polyether, acrylonitrile (ACN), dimethylformamide (DMF), ethyl acetate (EA), dimethyl carbonate (DMC), and ethyl propionate (EP).

When the raw materials for an alkali metal ion-conductive chalcogenide-based solid electrolyte are reacted in the polar aprotic solvent, ultrasonic irradiation, stirring, a high-speed homogenizer, a high-pressure sprayer, mechanical pulverization, or a combination thereof may be used.

The temperature during the reaction for preparing the first precursor solution may be, for example, −78° C. or higher, −60° C. or higher, −45° C. or higher, −30° C. or higher, or −15° C. or higher, and may also be 70° C. or lower, 55° C. or lower, 40° C. or lower, or 20° C. or lower. Specifically, the temperature during the reaction for preparing the first precursor solution may be −78° C. to 70°, more specifically −78° C. to 20° C.

In addition, the reaction for preparing the first precursor solution may be carried out with stirring. The stirring time may be, for example, 5 minutes or more, 10 minutes or more, 15 minutes or more, or 20 minutes or more, and may also be 120 minutes or less, 90 minutes or less, 60 minutes or less, or 45 minutes or less. Specifically, the stirring time during the reaction for preparing the first precursor solution may be 5 minutes to 120 minutes, more specifically 10 minutes to 60 minutes.

As a result, a first precursor solution, in which a precursor of an alkali metal ion-conductive chalcogenide-based solid electrolyte is completely dissolved in a polar aprotic solvent, may be prepared.

According to an embodiment, the precursor of an alkali metal ion-conductive chalcogenide-based solid electrolyte may be represented by the following Formula 1a.

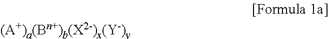

Here, A is one or more elements selected from Li, Na, and K; B is one or more elements belonging to Groups 2 to 15 of the periodic table; X is one or more elements selected from S, Se, and Te, or a combination thereof with O; Y is one or more elements or compounds selected from F, Cl, Br, I, CN, OCN, SCN, and N₃; and the values of 0≤a≤3, 4≤x≤6, and 0≤y≤2 are satisfied under the condition that b=1.

In the first precursor solution, the alkali metal-transfer catalyst radical formed by the reaction between the alkali metal-containing material and the transfer catalyst transfers alkali metal ions and electrons to the chalcogen element to form an alkali metal polychalcogenide, whereby it is dissolved in the solution, and the polychalcogenide reacts or mixes with the B element or Y element or a compound thereof, so that the first precursor of an alkali metal ion-conductive chalcogenide-based solid electrolyte can be completely dissolved in the solution.

The color of the first precursor solution may be, for example, yellow, red, or a mixed color thereof.

### Preparation, Recovery, and Thermal Treatment of a Second Precursor Slurry

In step (2), an alkali metal or an alkali metal-containing material is added to the first precursor solution to prepare a slurry in which a second precursor is dispersed.

According to an embodiment, in step (2), the alkali metal or alkali metal-containing material may be lithium metal; a mixture of lithium metal and a transfer catalyst; or a mixture of lithium metal, a transfer catalyst, and a polar aprotic solvent.

In step (2), the first precursor and the alkali metal or alkali metal-containing material react to cause a second precursor having a different composition from that of the first precursor to be precipitated and dispersed in the solution, thereby producing a slurry.

Once an alkali metal or an alkali metal-containing material has been added to the first precursor solution, it may be treated by one or more of ultrasonic irradiation, passage through a high-pressure homogenizer, mechanical pulverization, reaction rate with an alkali metal, and addition of a nonsolvent to control the particle size of the precursor in a slurry state, or the concentration of the alkali metal-transfer catalyst radical may be adjusted to inducing nucleus generation and growth of the precursor in a suspension state to thereby control the particle size of the second precursor.

The temperature during the reaction for preparing the second precursor solution may be, for example, −78° C. or higher, −60° C. or higher, −45° C. or higher, −30° C. or higher, or −15° C. or higher, and may also be 70° C. or lower, 55° C. or lower, 40° C. or lower, or 20° C. or lower. Specifically, the temperature during the reaction for preparing the second precursor solution may be −78° C. to 70°, more specifically −78° C. to 20° C.

In addition, the reaction time for preparing the second precursor solution may be, for example, 1 hour or more, 4 hours or more, 10 hours or more, or 18 hours or more, and may also be 72 hours or less, 60 hours or less, 45 hours or less, or 24 hours or less. Specifically, the reaction time for preparing the second precursor solution may be 1 hour to 72 hours, more specifically 4 hours to 24 hours.

The alkali metal added for the preparation of the second precursor in step (2) may be the same component as the alkali metal added for the preparation of the first precursor in step (1).

The amount of alkali metal (or the amount of alkali metal in the alkali metal-containing material) added in each of steps (1) and (2) may be controlled within a specific range.

First, the amount of alkali metal (or the amount of alkali metal in the alkali metal-containing material) added in step (1) may be, for example, 25 g or more, 35 g or more, 43 g or more, or 48 g or more, and may also be 195 g or less, 170 g or less, 145 g or less, or 130 g or less, based on 1,000 g of sulfur(S). Specifically, the amount of alkali metal added in step (1) may be 43 g to 145 g, more specifically 48 g to 130 g, based on 1,000 g of sulfur(S). Within the above preferred range, a solution that is completely soluble is prepared, whereby it may be more advantageous for producing a homogeneous solid electrolyte with high ionic conductivity.

Next, the amount of alkali metal (or the amount of alkali metal in the alkali metal-containing material) added in step (2) may be, for example, 230 g or more, 260 g or more, 289 g or more, or 303 g or more, and may also be 470 g or less, 430 g or less, 390 g or less, or 385 g or less, based on 1,000 g of sulfur(S). Specifically, the amount of alkali metal added in step (2) may be 289 g to 390 g, more specifically 303 g to 385 g, based on 1,000 g of sulfur(S). Within the above preferred range, lithium is completely reacted so that there is no residual lithium metal and organic lithium, which may be more advantageous in reducing impurities.

In addition, the ratio of the amount of alkali metal (or the amount of alkali metal in the alkali metal-containing material) added in steps (1) and (2) may be, for example, 1:10 to 1:1.5, specifically 1:9 to 1:2, more specifically 1:8 to 3:7. Within the above preferred range, it may be more advantageous for producing a homogeneous solid electrolyte with high ionic conductivity through a complete dissolution process.

In step (3), the second precursor is recovered in a powder form from the slurry.

In step (3), recovery of the second precursor may be carried out using co-precipitation, filtration, centrifugation, natural sedimentation, spray, hydrocyclone, or a combination thereof.

As a specific example, the second precursor may be recovered in a powder form by filtering the slurry under reduced pressure conditions.

In addition, in step (3), one or more processes of heat drying, solvent substitution, and spray drying may be further carried out on the slurry to enhance the precursor synthesis yield.

In step (4), the second precursor powder recovered is thermally treated.

The second precursor powder may first be heated or vacuum-dried to remove any residues of the polar aprotic solvent or the transfer catalyst.

The temperature during the heating or vacuum drying may be, for example, room temperature or higher, 25° C. or higher, 40° C. or higher, 60° C. or higher, 120° C. or higher, or 150° C. or higher, and may also be 300° C. or lower, 250° C. or lower, or 200° C. or lower. Specifically, the temperature during the heating or vacuum drying may be room temperature to 300° C., room temperature to 200° C., 25° C. to 200° C., or 120° C. to 200° C.

Thereafter, the second precursor powder may be crystallized by thermal treatment at a specific temperature.

The thermal treatment for crystallization may be carried out in an atmosphere of one or more of a vacuum, an inert gas, and hydrogen sulfide (H₂S) gas.

The temperature of the thermal treatment for crystallization may be, for example, 140° C. or higher, 200° C. or higher, 300° C. or higher, 400° C. or higher, or 500° C. or higher, and may also be 800° C. or lower, 700° C. or lower, or 600° C. or lower. Specifically, the temperature of the thermal treatment for crystallization may be 140° C. to 800° C., 140° C. to 600° C., 200° C. to 600° C., 300° C. to 600° C., or 400° C. to 600° C.

According to an embodiment, in step (4), the thermal treatment of the second precursor powder may comprise a process of removing residues by heating or vacuum drying at room temperature to 200° C. and then crystallizing it at 200° C. to 600° C. in an inert gas atmosphere.

When the thermal treatment is carried out under the above preferred conditions, there is an advantage in that a crystal structure of the solid electrolyte with high ionic conductivity can be obtained, and loss of sulfur and phosphorus due to volatilization can be suppressed. Specifically, under the above preferred thermal treatment conditions, it may be advantageous in preventing an excessive reduction in ionic conductivity due to deformation of the crystal structure caused by volatilization of the elements that constitute the solid electrolyte while diffusion between the constituent atoms of the solid electrolyte is sufficient.

According to the method of the present invention, as an alkali metal ion-conductive chalcogenide-based solid electrolyte precursor is synthesized and recovered in a powder form, followed by thermal treatment, an alkali metal ion (Li⁺, Na⁺, or K⁺) conductive chalcogenide-based solid electrolyte having a crystalline or glass-ceramic structure with high ionic conductivity can be readily synthesized without using such raw materials as Li₂S, Na₂S, and K₂S that are expensive and hard to store.

In addition, in an alkali metal-containing material to be reacted with a chalcogen element and one or more element compounds from Groups 2 to 15 and 17 of the periodic table in a polar aprotic solvent, an alkali metal alone may be used. In particular, when an alkali metal-transfer catalyst radical solution formed by reacting an alkali metal with a transfer catalyst in a polar aprotic solvent is prepared in advance and then reacted, there is an effect of reducing the time required to dissolve and react the alkali metal.

In addition, the particle size of the precursor in a suspended state can be controlled by ultrasonic irradiation, passage through a high-pressure homogenizer, and physical powder pulverization methods such as mechanical pulverization during the reaction for preparing a precursor solution, and the particle size of the precursor can be controlled by adjusting the concentration of the alkali metal ion-transfer catalyst radical to induce chemical nucleation and growth of the precursor in a suspended state.

In addition, after the alkali metal ion-conductive chalcogenide-based solid electrolyte precursor powder is recovered, the remaining solvent can be recovered and recycled in a batch or continuous manner for the first step of synthesizing the alkali metal ion-conductive chalcogenide-based solid electrolyte, which not only reduces costs but also has an advantageous effect on mass production.

### Alkali Metal Ion-Conductive Chalcogenide-Based Solid Electrolyte and All-Solid-State Battery

According to another aspect of the present invention, there is provided an alkali metal ion-conductive chalcogenide-based solid electrolyte prepared according to the method described above.

The alkali metal ion-conductive chalcogenide-based solid electrolyte according to an embodiment is represented by the following Formula 1.

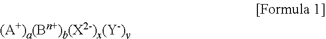

Here, A is one or more elements selected from Li, Na, and K; B is one or more elements belonging to Groups 2 to 15 of the periodic table; X is one or more elements selected from S, Se, and Te, or a combination thereof with O; Y is one or more elements or compounds selected from F, Cl, Br, I, CN, OCN, SCN, and N₃; a+(n*b)−(2*x)−y=0, a>0, x>0, and at least one of b and y is greater than 0.

In Formula 1, A is one or more elements selected from Li, Na, and K. For example, A may be Li or a combination thereof with at least one element from Na and K.

In Formula 1, B is one or more elements belonging to Groups 2 to 15 of the periodic table. For example, B is one or more elements belonging to Groups 13 to 15. More specifically, it may comprise elements of Group 15.

In Formula 1, X is one or more elements selected from S, Se, and Te, or a combination thereof with O. For example, X may be S, or a combination thereof with at least one element from Se and Te.

In Formula 1, Y is one or more elements or compounds selected from F, CI, Br, I, CN, OCN, SCN, and N₃. For example, Y may be at least one halogen element selected from F, Cl, Br, and I.

In Formula 1, a+(n*b)−(2*x)−y=0, a>0, x>0, and at least one of b and y is greater than 0. For example, a=7−y, b=1, x=6−y, 0.1≤y≤2.

The alkali metal ion-conductive chalcogenide solid electrolyte represented by the above Formula 1 may comprise a crystal structure of space group F-43m. Specifically, it may comprise an argyrodite crystal structure.

The solid electrolyte according to an embodiment may comprise an argyrodite crystal structure in an amount of 10% by weight or more, 30% by weight or more, 50% by weight or more, or 70% by weight or more, and 100% by weight or less, 90% by weight or less, or 80% by weight or less. Specifically, the solid electrolyte may comprise an argyrodite crystal structure in an amount of 50% by weight to 100% by weight.

According to a specific example, A is Li, B is P, X is S, Y is at least one halogen element selected from F, Cl, Br, and I, a=7-y, b=1, x=6-y, and 0.1≤y≤2, and it comprises an argyrodite crystal structure of space group F-43m in an amount of 50% by weight to 100% by weight.

The alkali metal ion-conductive chalcogenide-based solid electrolyte according to the present invention has ionic conductivity at a certain level or higher. The ionic conductivity of the solid electrolyte according to an embodiment immediately after its preparation may be 1.5 mS/cm or more, 2 mS/cm or more, 2.5 mS/cm or more, 3 mS/cm or more, or 3.5 mS/cm or more. For example, the ionic conductivity of the alkali metal ion-conductive chalcogenide-based solid electrolyte immediately after its preparation may be 3 mS/cm or more. Meanwhile, the upper limit of the ionic conductivity is not particularly limited, but it may be, for example, 10 mS/cm or less, 8 mS/cm or less, 6 mS/cm or less, or 5 mS/cm or less. As a specific example, the ionic conductivity of the alkali metal ion-conductive chalcogenide-based solid electrolyte immediately after its preparation may be 1.5 mS/cm to 10 mS/cm, 2 mS/cm to 8 mS/cm, 2.5 mS/cm to 6 mS/cm, or 3 mS/cm to 5 mS/cm.

In addition, the alkali metal ion-conductive chalcogenide-based solid electrolyte according to the present invention has a carbon content at a certain level or lower. For example, the carbon content of the solid electrolyte according to an embodiment may be 10% or less, 7% or less, or 5% or less. Specifically, the carbon content of the alkali metal ion-conductive chalcogenide-based solid electrolyte may be 3% or less. More specifically, the carbon content of the alkali metal ion-conductive chalcogenide-based solid electrolyte may be 1% or less.

According to another aspect of the present invention, there is provided an all-solid-state battery, which comprises the alkali metal ion-conductive chalcogenide-based solid electrolyte described above.

The all-solid-state battery may comprise a positive electrode, a negative electrode, and a solid electrolyte interposed between them.

The positive electrode may comprise a positive electrode active material, a solid electrolyte, a conductive material, a binder, and the like. In addition, any other known material that can be used in an all-solid-state battery may be used. The positive electrode active material may comprise stainless steel, aluminum, nickel, titanium, sintered carbon, or the like. In addition, any other material having high conductivity without causing chemical change may be used. In addition, the positive electrode active material may be surface-treated with carbon, nickel, titanium, silver, or the like.

The negative electrode may comprise a negative electrode active material, a solid electrolyte, a conductive material, a binder, and the like. In addition, any other known material that can be used in an all-solid-state battery may be used. The negative electrode active material may comprise copper, stainless steel, aluminum, nickel, titanium, sintered carbon, or the like. In addition, any other material having high conductivity without causing chemical change may be used. In addition, the negative electrode active material may be surface-treated with carbon, nickel, titanium, silver, or the like.

The all-solid-state battery according to an embodiment comprises an alkali metal ion-conductive chalcogenide-based solid electrolyte represented by the following Formula 1.

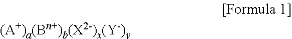

Here, A is one or more elements selected from Li, Na, and K; B is one or more elements belonging to Groups 2 to 15 of the periodic table; X is one or more elements selected from S, Se, and Te, or a combination thereof with O; Y is one or more elements or compounds selected from F, Cl, Br, I, CN, OCN, SCN, and N₃; a+(n*b)−(2*x)−y=0, a>0, x>0, and at least one of b and y is greater than 0.

The description of the solid electrolyte of Formula 1 is as described above.

According to a specific example, A is Li, B is P, X is S, Y is at least one halogen element selected from F, Cl, Br, and I, a=7-y, b=1, x=6-y, and 0.1≤y≤2, and it comprises an argyrodite crystal structure of space group F-43m in an amount of 50% by weight to 100% by weight.

### MODE FOR THE INVENTION

Hereinafter, a preferred embodiment is presented for the understanding of the present invention. However, the scope of the present invention is not limited by the following examples.

### Examples 1 to 16

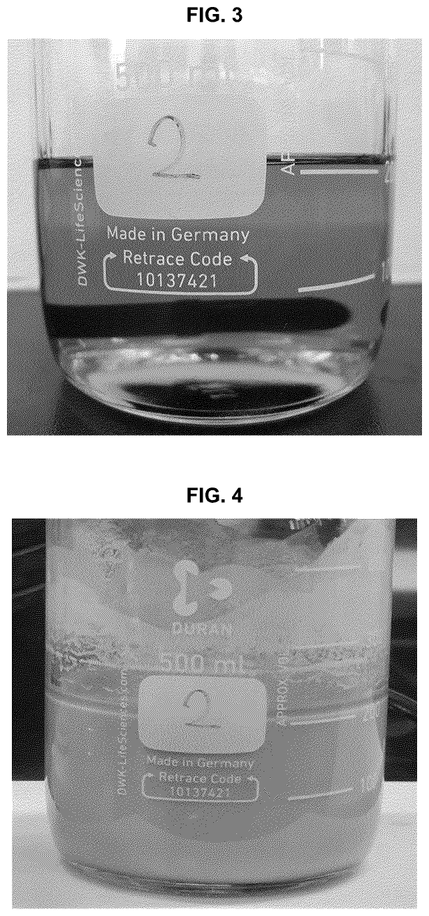

The process for preparing a solid electrolyte described below was carried out in a cooling tank at 0° C. until filtration. Naphthalene (NAP) was dissolved in tetrahydrofuran (THF). Lithium metal (1^{st} Li in Table 1) was added thereto to form lithium polysulfide (Li₂Sₓ, 1<x≤10) and lithium sulfide (Li₂S) and dissolved for 30 minutes. Then, sulfur(S) was added thereto and reacted for 30 minutes. Lithium chloride (LiCl) and phosphorus pentasulfide (P₂S₅) were added to the reaction solution and completely dissolved for 1 hour to prepare a first precursor solution. A photograph of the solution in which the first precursor was completely dissolved is shown in FIG. 3. It was confirmed to be a transparent complete solution in yellowish color.

Thereafter, lithium metal (2^{nd} Li in Table 1) was added to the first precursor solution, thereby completing the addition of all raw materials. The solution containing all the raw materials changed from black to green and then beige, while a synthesis reaction occurred in which powder was formed. The reaction was completed in 24 hours as a slurry in which a second precursor was dispersed was formed. A photograph of the slurry in which the second precursor was dispersed is shown in FIG. 4. It was confirmed that the supernatant and the powder-dense portion were observed because the slurry in which the second precursor was dispersed was in a powder-dispersed state.

The slurry upon completion of the reaction was filtered under a reduced pressure to obtain a powder. This powder was dried at 200° C. for 14 hours in a vacuum atmosphere and thermally treated at 550° C. for 4 hours in an Ar atmosphere to obtain a final solid electrolyte powder.

The amount of each component added in Examples 1 to 16 is shown in the table below.

TABLE 1

| (Unit: g) | THF | NAP | 1^{st} Li | S | LiCl | P₂S₅ | 2^{nd} Li |
|---|---|---|---|---|---|---|---|
| Ex. 1 | 300 | 21.491 | 0.388 | 8.960 | 4.739 | 12.323 | 3.491 |
| Ex. 2 | 300 | | 0.431 | | | | 3.448 |
| Ex. 3 | 300 | | 0.485 | | | | 3.394 |
| Ex. 4 | 300 | | 0.554 | | | | 3.325 |
| Ex. 5 | 300 | | 0.647 | | | | 3.233 |
| Ex. 6 | 300 | | 0.776 | | | | 3.103 |
| Ex. 7 | 300 | | 0.970 | | | | 2.909 |
| Ex. 8 | 300 | | 1.293 | | | | 2.586 |
| Ex. 9 | 180 | | 0.388 | | | | 3.491 |
| Ex. 10 | 180 | | 0.431 | | | | 3.448 |
| Ex. 11 | 180 | | 0.485 | | | | 3.394 |
| Ex. 12 | 180 | | 0.554 | | | | 3.325 |
| Ex. 13 | 180 | | 0.647 | | | | 3.233 |
| Ex. 14 | 180 | | 0.776 | | | | 3.103 |
| Ex. 15 | 180 | | 0.970 | | | | 2.909 |
| Ex. 16 | 180 | | 1.293 | | | | 2.586 |

### Comparative Example 1

21.491 g of naphthalene was dissolved in 300 ml of tetrahydrofuran. 1.940 g of lithium metal was added first and reacted for 1 hour, and then 8.960 g of sulfur was added. 4.739 g of lithium chloride and 12.323 g of phosphorus pentasulfide were added to the solution and dissolved. The solution was not completely dissolved, resulting in a slurry containing powder. 1.939 g of lithium metal was added to the slurry to complete the addition of all raw materials. Finally, the reaction was completed as a slurry in which a second precursor was dispersed was formed. The slurry upon completion of the reaction was filtered under a reduced pressure to obtain a powder. This powder was dried at 200° C. for 14 hours in a vacuum atmosphere and thermally treated at 550° C. for 4 hours in an Ar atmosphere to obtain a final solid electrolyte powder.

### Comparative Example 2

21.491 g of naphthalene (NAP) was dissolved in 300 ml of tetrahydrofuran. 3.879 g of lithium metal was added and reacted for 1 hour, and then 8.960 g of sulfur was added. 4.739 g of lithium chloride and 12.323 g of phosphorus pentasulfide were added to the reaction solution to complete the addition of all raw materials. Upon completion of the reaction, the slurry obtained was filtered under a reduced pressure to obtain a powder. This powder was dried at 200° C. for 14 hours in a vacuum atmosphere and thermally treated at 550° C. for 4 hours in an Ar atmosphere to obtain a final solid electrolyte powder.

### Comparative Example 3

21.491 g of naphthalene, 3.879 g of lithium metal, 8.960 g of sulfur, 4.739 g of lithium chloride, and 12.323 g of phosphorus pentasulfide were all added to 300 ml of tetrahydrofuran and reacted for 24 hours to obtain a slurry. This slurry was filtered under a reduced pressure to obtain a powder. This powder was dried at 200° C. for 14 hours in a vacuum atmosphere and thermally treated at 550° C. for 4 hours in an Ar atmosphere to obtain a final solid electrolyte powder.

### Test Example 1: Evaluation of the Ionic Conductivity of a Solid Electrolyte

0.2 g of each solid electrolyte prepared in the examples and comparative examples was compression molded at 300 MPa in a circular mold with a diameter of 13 mm, and the AC impedance analysis method was performed. The frequency range was 3 MHz to 1 Hz, and the amplitude was 10 mV. The results of the ionic conductivity evaluation are shown in the table below.

TABLE 2

| | Average ionic conductivity | Deviation (maximum − minimum) |
|---|---|---|
| | (mS/cm) | (mS/cm) |
| Ex. 1 | 3.5 | 0.2 |
| Ex. 2 | 3.4 | 0.2 |
| Ex. 3 | 3.2 | 0.2 |
| Ex. 4 | 3.2 | 0.3 |
| Ex. 5 | 3.1 | 0.2 |
| Ex. 6 | 3.0 | 0.2 |
| Ex. 7 | 3.0 | 0.3 |
| Ex. 8 | 3.0 | 0.3 |
| Ex. 9 | 4.0 | 0.2 |
| Ex. 10 | 3.9 | 0.2 |
| Ex. 11 | 3.8 | 0.2 |
| Ex. 12 | 3.5 | 0.3 |
| Ex. 13 | 3.5 | 0.2 |
| Ex. 14 | 3.5 | 0.2 |
| Ex. 15 | 3.5 | 0.3 |
| Ex. 16 | 3.5 | 0.3 |
| C. Ex. 1 | 1.2 | 1.0 |
| C. Ex. 2 | 1.2 | 1.1 |
| C. Ex. 3 | 1.2 | 1.0 |

### Test Example 2: X-Ray Diffraction Analysis of a Solid Electrolyte

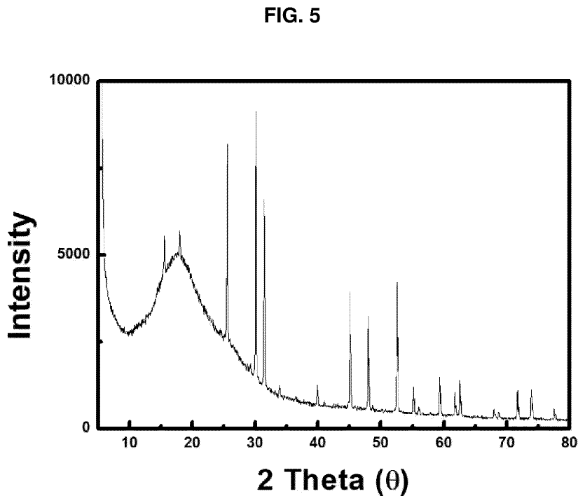

X-ray diffraction analysis (XRD) was performed on the solid electrolyte prepared in Example 1. The results are shown in FIG. 5.

Referring to FIG. 5, main peaks were shown for the alkali metal ion-conductive chalcogenide-based solid electrolyte prepared in Example 1 at diffraction angles (2θ) in the ranges of 15.5±0.5°, 18.0±0.5°, 25.5±0.5°, 30.0±0.5°, 31.5±0.5°, 40.0±0.5°, 45.5±0.5°, 48.0±0.5°, 53.0±0.5°, 55.0±0.5°, 56.5±0.5°, and 59.5±0.5°. These peaks are identical to those of Li₆PS₅Cl, an argyrodite-type crystal structure of space group F-43m. Peaks attributed to impurities were detected at relatively low levels. Accordingly, the alkali metal ion-conductive chalcogenide-based solid electrolyte prepared in Example 1 was confirmed to be an alkali metal ion-conductive chalcogenide-based solid electrolyte having an argyrodite-type crystal structure.

### Test Example 3: Ionic Conductivity and Particle Size after Pulverization of a Solid Electrolyte

In this test example, the solid electrolyte of Example 1 was pulverized and then its ionic conductivity and particle size were measured.

For pulverization, 1,124 g of zirconia balls with a diameter of 10 mm, 376 g of zirconia balls with a diameter of 1 mm, 60 g of the solid electrolyte, 192 ml of normal heptane, and 48 ml of dibutyl ether were all charged to a polypropylene container having a volume of 1 liter and ball-milled at a speed of 200 rpm for 20 hours. Thereafter, the powder was collected by filtration and dried in a vacuum at 90° C. for 20 hours.

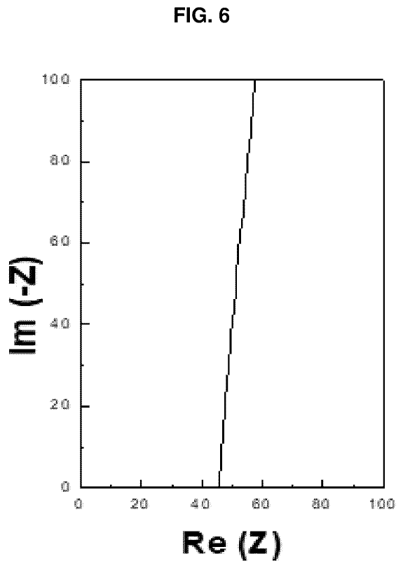

The ionic conductivity of the pulverized powder was measured using the same method as in Test Example 1, which was 1.8 mS/cm (see FIG. 6).

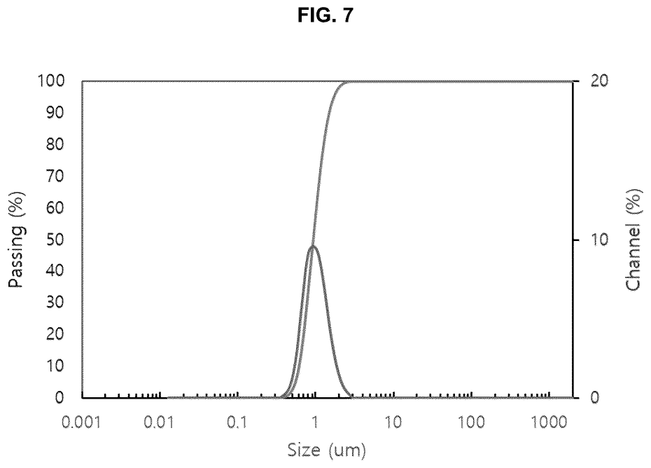

In addition, the particle size of the pulverized powder was analyzed using a particle size analyzer (Microtrac S3500), which was 0.93 μm based on D50 (see FIG. 7). Xylene was used as the dispersion solvent during the particle size analysis.

In addition, the ionic conductivity of the pulverized powder was measured before and after exposure to air to evaluate its atmospheric stability. For this purpose, 0.15 g was collected from each of two random portions of the pulverized powder. One of them was measured for ionic conductivity without exposure to air, and the other was measured for ionic conductivity after 24 hours of exposure to dry air with a dew point of −60° C.

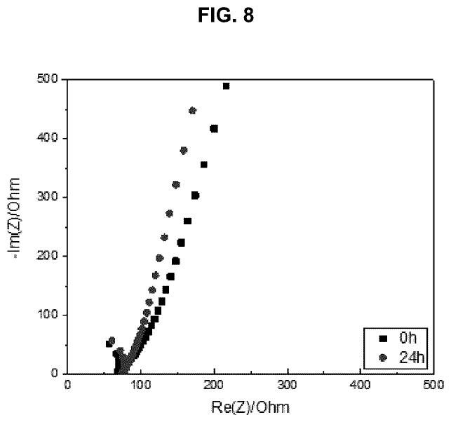

The ionic conductivity measurements were performed using the AC impedance analysis method using compression molding at 400 MPa in a circular mold with a diameter of 10 mm. The frequency range was 1 MHz to 0.1 Hz, and the amplitude was 10 mV. The results showing a retention rate of ionic conductivity of 87% among the results are shown in FIG. 8. The solid electrolytes of all the examples showed a retention rate of ionic conductivity of 80%±10% in the pulverized powder.

### Test Example 4: Performance Evaluation of an all-Solid-State Battery

The performance of an all-solid-state battery in which a powdered solid electrolyte had been adopted was evaluated.

0.7 g of LiNbO₃-coated NCM811, 0.3 g of the solid electrolyte powder of Example 1 as pulverized in Test Example 3, and 0.03 g of VGCF (vapor growth carbon nanotubes) were mixed three times for 30 seconds using a Thinky mixer to prepare a positive electrode layer composite powder. 0.1 g of the pulverized solid electrolyte powder was placed in a mold with a diameter of 10 mm and compressed at 300 MPa to form a pellet. Then, 0.1 g of the positive electrode composite powder was placed on one side of the pellet and compressed at 300 MPa again. Thereafter, lithium metal foil and indium metal foil were sequentially laminated on the opposite side, which was finally compression molded at 50 MPa to form an all-solid-state battery. Charge and discharge experiments of the prepared all-solid-state battery were performed at a terminal voltage of 3.7 V to 2.4 V at a C-rate of 0.1.

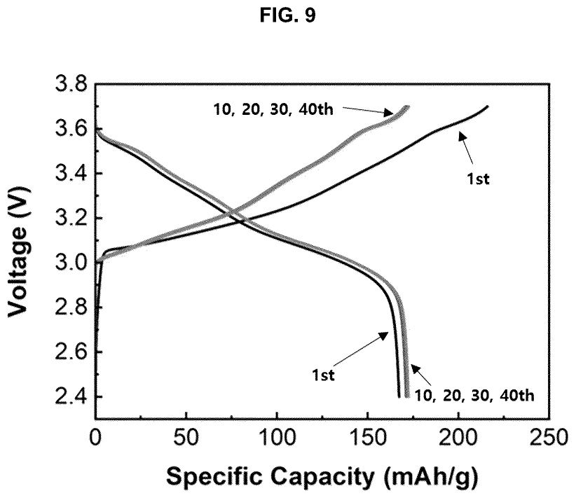

The results are shown in FIG. 9, which shows a very stable charge and discharge curve.

### Test Example 5: Analysis of the Anions of a First Precursor

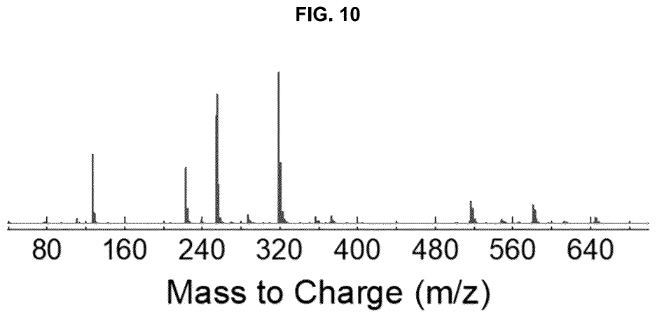

The anions contained in the first precursor were analyzed using an electrospray ionization mass spectrometer. The solution in which the first precursor was completely dissolved in Example 3 was analyzed using an electrospray ionization mass spectrometer. The results are shown in FIG. 10.

As can be seen from FIG. 10, signals corresponding to 126.9, 222.8, 254.8, 286.7, 318.7, 452.6, 516.6, 548.5, 580.5, 612.6, and 644.5 m/z were confirmed. The presence of fully soluble chalcogenide ions respectively corresponding to PS₃—, PS₆—, PS₇—, PS₈—, PS₉—, LiP₂S₁₂—, LiP₂S₁₄—, LiP₂S₁₅—, LiP₂S₁₆—, LiP₂S₁₇—, and LiP₂S₁₈— was confirmed.

What is claimed is:

1. A method for preparing an alkali metal ion-conductive chalcogenide-based solid electrolyte, which comprises:
(1) preparing a first precursor solution in which a precursor of an alkali metal ion-conductive chalcogenide-based solid electrolyte is completely dissolved in a polar aprotic solvent;
(2) adding an alkali metal or an alkali metal-containing material to the first precursor solution to prepare a slurry in which a second precursor is dispersed;
(3) recovering the second precursor in a powder form from the slurry; and
(4) thermally treating the second precursor powder.

2. The method for preparing an alkali metal ion-conductive chalcogenide-based solid electrolyte according to claim 1, wherein the first precursor solution in step (1) is prepared by reacting raw materials for an alkali metal ion-conductive chalcogenide-based solid electrolyte, which comprise (i) an alkali metal or an alkali metal-containing material, (ii) a transfer catalyst that ionizes the alkali metal to transfer ions and electrons, (iii) a chalcogen element, and (iv) one or more element compounds from Groups 2 to 15 and 17 of the periodic table, in the polar aprotic solvent.

3. The method for preparing an alkali metal ion-conductive chalcogenide-based solid electrolyte according to claim 2, wherein the transfer catalyst is selected from the group consisting of naphthalene, acenaphthylene, acenaphthene, biphenyl, fluorene, phenanthrene, anthracene, fluoranthene, pyrene, benzo[a]anthracene, chrysene, benzo[k]fluoranthene, benzo[b]fluoranthene, benzo[a]pyrene, indeno[1,2,3-cd]pyrene, dibenz[a,h]anthracene, and benzo[ghi]perylene.

4. The method for preparing an alkali metal ion-conductive chalcogenide-based solid electrolyte according to claim 2, wherein the polar aprotic solvent is at least one selected from the group consisting of an aliphatic monoether, an aliphatic diether, a cyclic ether, a polyether, acrylonitrile (ACN), dimethylformamide (DMF), ethyl acetate (EA), dimethyl carbonate (DMC), and ethyl propionate (EP).

5. The method for preparing an alkali metal ion-conductive chalcogenide-based solid electrolyte according to claim 2, wherein when the raw materials for an alkali metal ion-conductive chalcogenide-based solid electrolyte are reacted in the polar aprotic solvent, ultrasonic irradiation, stirring, a high-speed homogenizer, a high-pressure sprayer, mechanical pulverization, or a combination thereof is used.

6. The method for preparing an alkali metal ion-conductive chalcogenide-based solid electrolyte according to claim 1, wherein the precursor in step (1) is represented by the following Formula 1a: 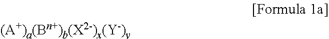
wherein A is one or more elements selected from Li, Na, and K; B is one or more elements belonging to Groups 2 to 15 of the periodic table; X is one or more elements selected from S, Se, and Te, or a combination thereof with O; Y is one or more elements or compounds selected from F, Cl, Br, I, CN, OCN, SCN, and N₃; and the values of 0≤a≤3, 4≤x≤6, and 0≤y≤2 are satisfied under the condition that b=1.

7. The method for preparing an alkali metal ion-conductive chalcogenide-based solid electrolyte according to claim 1, wherein the alkali metal or alkali metal-containing material in step (2) is lithium metal; a mixture of lithium metal and a transfer catalyst; or a mixture of lithium metal, a transfer catalyst, and a polar aprotic solvent.

8. The method for preparing an alkali metal ion-conductive chalcogenide-based solid electrolyte according to claim 1, wherein recovery of the second precursor in step (3) is carried out using co-precipitation, filtration, centrifugation, natural sedimentation, spray, hydrocyclone, or a combination thereof.

9. The method for preparing an alkali metal ion-conductive chalcogenide-based solid electrolyte according to claim 1, wherein the thermal treatment of the second precursor powder in step (4) comprises a process of removing residues by heating or vacuum drying at room temperature to 200° C. and then crystallizing it at 200° C. to 600° C. in an inert gas atmosphere.

10. An alkali metal ion-conductive chalcogenide-based solid electrolyte, which is prepared according to the method of claim 1 and represented by the following Formula 1: 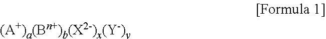
wherein A is one or more elements selected from Li, Na, and K; B is one or more elements belonging to Groups 2 to 15 of the periodic table; X is one or more elements selected from S, Se, and Te, or a combination thereof with O; Y is one or more elements or compounds selected from F, Cl, Br, I, CN, OCN, SCN, and N₃; a+(n*b)−(2*x)−y=0, a>0, x>0, and at least one of b and y is greater than 0.

11. The alkali metal ion-conductive chalcogenide-based solid electrolyte of claim 10, wherein A is Li, B is P, X is S, Y is at least one halogen element selected from F, Cl, Br, and I, a=7−y, b=1, x=6−y, and 0.1≤y≤2, and it comprises an argyrodite crystal structure of space group F-43m in an amount of 50% by weight to 100% by weight.

12. The alkali metal ion-conductive chalcogenide-based solid electrolyte of claim 10, wherein the ionic conductivity of the alkali metal ion-conductive chalcogenide-based solid electrolyte immediately after its preparation is 3 mS/cm or more.

13. The alkali metal ion-conductive chalcogenide-based solid electrolyte of claim 10, wherein the carbon content of the alkali metal ion-conductive chalcogenide-based solid electrolyte is 3% or less.

14. An all-solid-state battery, which comprises the alkali metal ion-conductive chalcogenide-based solid electrolyte of claim 10.
